(19) United States
(12) Patent Application Publication
(10) Pub. No.: US 2014/0358294 A1
(43) Pub. Date: Dec. 4, 2014

(54) PERCEIVED COMFORT TEMPERATURE CONTROL

(71) Applicant: HONEYWELL INTERNATIONAL INC., Morristown, NJ (US)

(72) Inventors: Steven C. Nichols, Plymouth, MN (US); Jeffrey Hammer, Brooklyn Center, MN (US)

(73) Assignee: Honeywell International Inc., Morristown, NJ (US)

(21) Appl. No.: 13/905,379

(22) Filed: May 30, 2013

(51) Int. Cl. G05D 23/19

(52) U.S. Cl. CPC G05D 23/1919
USPC 700/278

(57) ABSTRACT

Many different factors may affect a user's perceived thermal comfort level within a building. Controlling a room temperature according to what the temperature may feel like to a user (i.e. the “feels-like” temperature) may increase a user's comfort level in the building. An HVAC controller may be programmed to determine a temperature offset based on one or more environmental conditions in and/or around the building, and to apply the temperature offset to the indoor temperature, resulting in a feels-like temperature. The HVAC controller may be further programmed to control an HVAC system in accordance with the feels-like temperature.

### TECHNICAL FIELD

The present disclosure relates generally to HVAC controllers, and more particularly, to HVAC controllers that control the temperature of an inside space.

### BACKGROUND

Heating, ventilation, and/or air conditioning (HVAC) systems are often used to control the comfort level within a building or other structure. Such HVAC systems typically include an HVAC controller that controls various HVAC components of the HVAC system in order to affect and/or control one or more environmental conditions within the building. In many cases, the HVAC controller may be configured to sense and to control a dry bulb temperature within the building. However, a variety of factors may affect a user's perceived comfort level at a particular dry bulb temperature. As such, controlling a room temperature according to what the temperature may feel like to a user (i.e. a “feels-like” temperature) may increase a user's comfort level.

### SUMMARY

The present disclosure relates generally to HVAC controllers, and more particularly, to HVAC controllers that control the temperature inside a building or structure. In one example, an HVAC controller for controlling one or more HVAC components of an HVAC system may include a memory storing a control algorithm for controlling the one or more HVAC components of the HVAC system. The memory may further store a temperature set point. An input port of the HVAC controller may receive a measure related to an indoor temperature inside the building or structure, a measure related to an indoor humidity inside the building or structure, and a measure related to an outdoor temperature outside of the building or structure. The HVAC controller may also include a controller coupled to the memory and the input port. The HVAC controller may also include a user interface including a display. The user interface may be located at the HVAC controller or at a remote device that is in communication with the HVAC controller.

In some instances, the controller may be programmed to determine a temperature offset based, at least in part, on the measure related to the indoor humidity and/or the measure related to the outdoor temperature, and to use the temperature offset in the control algorithm when controlling the HVAC system. In some cases, the controller may be programmed to apply the temperature offset to the temperature set point stored in the memory, resulting in a feels-like temperature set point, and the control algorithm may be configured to control the HVAC system in a manner that attempts to drive the sensed indoor temperature toward the feels-like temperature set point. In other cases, the controller may be programmed to apply the temperature offset to the indoor temperature, resulting in a feels-like temperature, and the control algorithm may be configured to control the HVAC system in a manner that attempts to drive the feels-like temperature toward the temperature set point stored in the memory.

The preceding summary is provided to facilitate an understanding of some of the innovative features unique to the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following description of various illustrative embodiments in connection with the accompanying drawings, in which:

FIG. 1 is a schematic view of an illustrative HVAC system servicing a building or structure;

FIG. 2 is a schematic view of an illustrative HVAC control system that may facilitate access and/or control of the HVAC system of FIG. 1;

FIG. 3 is a schematic block diagram of an illustrative HVAC controller;

FIG. 4 is a flow diagram of an illustrative process utilized by an HVAC controller to determine a feels-like temperature;

FIG. 5 is a schematic view of an illustrative HVAC controller;

FIGS. 6 and 7 are graphical representations of an algorithm that may be used to determine a correction factor or offset;

FIG. 8 is a graphical representation of a PMV sensation scale;

FIG. 9 is a graphical representation of another PMV sensation scale; and

FIG. 10 is a flow chart of an illustrative method of controlling an HVAC system according to a feels-like temperature.

While the disclosure is amenable to various modifications and alternative forms, specifics thereof have been shown by way of example in the drawings and will be described in detail. It should be understood, however, that the intention is not to limit aspects of the disclosure to the particular examples shown. On the contrary, the intention is to cover all modifications, equivalents, and alternatives falling within the spirit and scope of the disclosure.

### DESCRIPTION

The following description should be read with reference to the drawings wherein like reference numerals indicate like elements throughout the several views. The description and drawings show several embodiments which are meant to illustrative in nature.

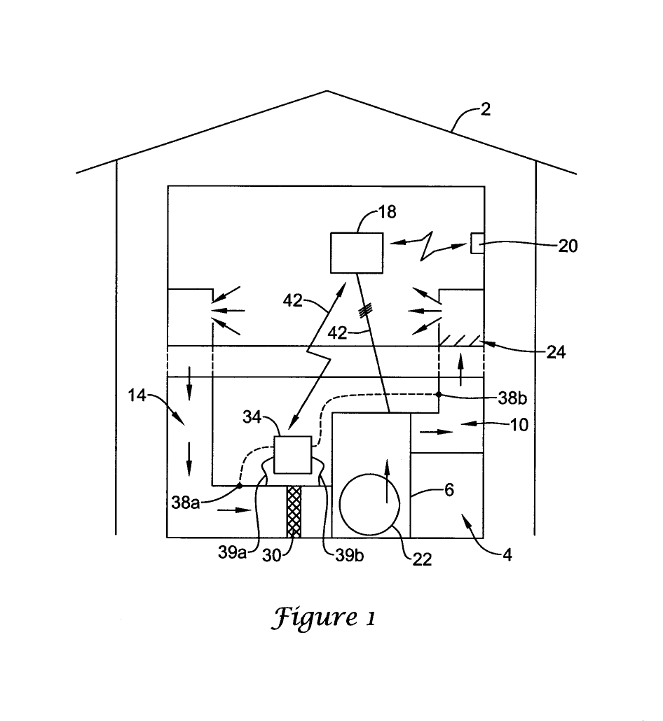

FIG. 1 is a schematic view of a building 2 having an illustrative heating, ventilation, and air conditioning (HVAC) system 4. While FIG. 1 shows a typical forced air type HVAC system, other types of HVAC systems are contemplated including, but not limited to, boiler systems, radiant heating systems, electric heating systems, cooling systems, heat pump systems, and/or any other suitable type of HVAC system, as desired. The illustrative HVAC system 4 of FIG. 1 includes one or more HVAC components 6, a system of ductwork and air vents including a supply air duct 10 and a return air duct 14, and one or more HVAC controllers 18. The one or more HVAC components 6 may include, but are not limited to, a furnace, a heat pump, an electric heat pump, a geothermal heat pump, an electric heating unit, an air conditioning unit, a humidifier, a dehumidifier, an air exchanger, an air cleaner, a damper, a valve, and/or the like.

It is contemplated that the HVAC controller(s) 18 may be configured to control the comfort level in the building or structure by activating and deactivating the HVAC component(s) 6 in a controlled manner. The HVAC controller(s) 18 may be configured to control the HVAC component(s) 6 via a wired or wireless communication link 20. In some cases, the HVAC controller(s) 18 may be a thermostat, such as, for example, a wall mountable thermostat, but this is not required in all embodiments. Such a thermostat may include (e.g. within the thermostat housing) or have access to a temperature sensor for sensing an ambient temperature inside of the building 2. Likewise, such a thermostat may include (e.g. within the thermostat housing) or have access to a humidity sensor for sensing a humidity level inside of the building 2. Also, such a thermostat may receive a measure related to ambient temperature and/or humidity level outside of the building 2. These are just some examples. It is contemplated that such a thermostat may receive a measure related to any suitable environmental parameter inside and/or outside of the building. Some suitable parameters may further include, for example, outside wind speed, outside wind direction, outside humidity, solar load, geographic location of the building, time of day, time of year, blower or fan speed of the HVAC system (which may be related to an air flow speed within the building), etc. In some instances, the HVAC controller(s) 18 may be a zone controller, or may include multiple zone controllers each monitoring and/or controlling the comfort level within a particular zone in the building or other structure.

In the illustrative HVAC system 4 shown in FIG. 1, the HVAC component(s) 6 may provide heated air (and/or cooled air) via the ductwork throughout the building 2. As illustrated, the HVAC component(s) 6 may be in fluid communication with every room and/or zone in the building 2 via the ductwork 10 and 14, but this is not required. In operation, when a heat call signal is provided by the HVAC controller(s) 18, an HVAC component 6 (e.g. forced warm air furnace) may be activated to supply heated air to one or more rooms and/or zones within the building 2 via supply air ducts 10. The heated air may be forced through supply air duct 10 by a blower or fan 22. In this example, the cooler air from each zone may be returned to the HVAC component 6 (e.g. forced warm air furnace) for heating via return air ducts 14. Similarly, when a cool call signal is provided by the HVAC controller(s) 18, an HVAC component 6 (e.g. air conditioning unit) may be activated to supply cooled air to one or more rooms and/or zones within the building or other structure via supply air ducts 10. The cooled air may be forced through supply air duct 10 by the blower or fan 22. In this example, the warmer air from each zone may be returned to the HVAC component 6 (e.g. air conditioning unit) for cooling via return air ducts 14. The HVAC system 4 may include an internet gateway or other device 20 that may allow one or more of the HVAC components, as described herein, to communicate over a wide area network (WAN) such as, for example, the Internet. In some cases, the gateway device 20 may be integrated into the HVAC controller 18, but this is not required.

In some cases, the system of vents or ductwork 10 and/or 14 can include one or more dampers 24 to regulate the flow of air, but this is not required. For example, one or more dampers 24 may be coupled to one or more HVAC controller(s) 18, and can be coordinated with the operation of one or more HVAC components 6. The one or more HVAC controller(s) 18 may actuate dampers 24 to an open position, a closed position, and/or a partially open position to modulate the flow of air from the one or more HVAC components to an appropriate room and/or zone in the building or other structure. The dampers 24 may be particularly useful in zoned HVAC systems, and may be used to control which zone(s) receives conditioned air from the HVAC component(s) 6.

In many instances, one or more air filters 30 may be used to remove dust and other pollutants from the air inside the building 2. In the illustrative example shown in FIG. 1, the air filter(s) 30 is installed in the return air duct 14, and may filter the air prior to the air entering the HVAC component 6, but it is contemplated that any other suitable location for the air filter(s) 30 may be used. The presence of the air filter(s) 30 may not only improve the indoor air quality, but may also protect the HVAC components 6 from dust and other particulate matter that would otherwise be permitted to enter the HVAC component.

In some cases, and as shown in FIG. 1, the illustrative HVAC system 4 may include an equipment interface module (EIM) 34. When provided, the equipment interface module 34 may be configured to measure or detect a change in a given parameter between the return air side and the discharge air side of the HVAC system 4. For example, the equipment interface module 34 may be adapted to measure a difference in temperature, flow rate, pressure, or a combination of any one of these parameters between the return air side and the discharge air side of the HVAC system 4. In some cases, the equipment interface module 34 may be adapted to measure the difference or change in temperature (delta T) between a return air side and discharge air side of the HVAC system 4 for the heating and/or cooling mode. The delta T for the heating mode may be calculated by subtracting the return air temperature from the discharge air temperature (e.g. delta T=discharge air temp.−return air temp.). For the cooling mode, the delta T may be calculated by subtracting the discharge air temperature from the return air temperature (e.g. delta T=return air temp.−discharge air temp.).

In some cases, the equipment interface module 34 may include a first temperature sensor 38a located in the return (incoming) air duct 14, and a second temperature sensor 38b located in the discharge (outgoing or supply) air duct 10. Alternatively, or in addition, the equipment interface module 34 may include a differential pressure sensor including a first pressure tap 39a located in the return (incoming) air duct 14, and a second pressure tap 39b located downstream of the air filter 30 to measure a change in a parameter related to the amount of flow restriction through the air filter 30. In some cases, the equipment interface module 34, when provided, may include at least one flow sensor that is capable of providing a measure that is related to the amount of air flow restriction through the air filter 30. In some cases, the equipment interface module 34 may include an air filter monitor. These are just some examples.

When provided, the equipment interface module 34 may be configured to communicate with the HVAC controller 18 via a wired or wireless communication link 42. In other cases, the equipment interface module 34 may be incorporated or combined with the HVAC controller 18. In either cases, the equipment interface module 34 may communicate, relay or otherwise transmit data regarding the selected parameter (e.g. temperature, pressure, flow rate, etc.) to the HVAC controller 18. In some cases, the HVAC controller 18 may use the data from the equipment interface module 34 to evaluate the system's operation and/or performance. For example, the HVAC controller 18 may compare data related to the difference in temperature (delta T) between the return air side and the discharge air side of the HVAC system 4 to a previously determined delta T limit stored in the HVAC controller 18 to determine a current operating performance of the HVAC system 4.

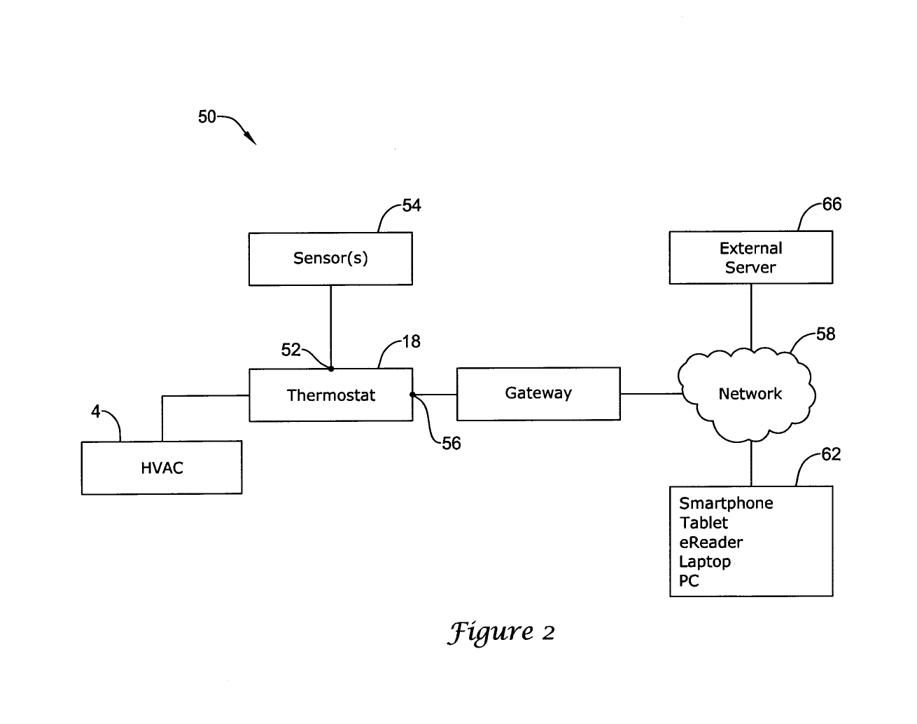

FIG. 2 is a schematic view of an HVAC control system 50 that may facilitates remote access and/or control of the HVAC system 4 shown in FIG. 1. The illustrative HVAC control system 50 includes an HVAC controller, as for example, HVAC controller 18 (see FIG. 1) that is configured to communicate with and control one or more components 6 of the HVAC system 4. As discussed above, the HVAC controller 18 may communicate with the one or more components 6 of the HVAC system 4 via a wired or wireless link. As shown in FIG. 2, the HVAC controller 18 may include an input port 52 for communicating with one or more internal and/or remote sensors 54 such as, for example, an internal temperature sensor, an internal humidity sensor, a remote indoor temperature sensor, a remote indoor humidity sensor, a remote outdoor temperature sensor, a remote outdoor humidity sensor, a remote solar sensor, a remote wind speed sensor, and/or any other suitable sensor, as desired. In some cases, the input port 52 may be a wireless input port adapted to receive a wireless signal from one of the aforementioned sensors over a wireless network such as, for example, a wireless local area network (LAN). In addition, the input port 52 may be coupled to one or more internal sensors such as an internal temperature sensor and/or an indoor humidity sensor. Additionally, the HVAC controller 18 may include a network port 56 (which may be part of the input port 52 or separate from the input port) that facilitates communication over one or more wired or wireless networks 58, and that may accommodate remote access and/or control of the HVAC controller 18 via another device 62 such as a cell phone, tablet, e-reader, laptop computer, personal computer, key fob, or the like. The network port 56 may also be used to receive environmental condition data, such as outdoor temperature, outdoor humidity, wind speed and/or direction, solar load, etc., from a remote location such as a remote web server.

Depending upon the application and/or where the HVAC user is located, remote access and/or control of the HVAC controller 18 may be provided over the network 58. The network may be a wireless local area network (LAN) or a wide area network (WAN) such as, for example, the Internet. A variety of mobile wireless devices 62 may be used to access and/or control the HVAC controller 18 from a remote location (e.g. remote from HVAC Controller 18) over the network 58 including, but not limited to, mobile phones including smart phones, PDAs, tablet computers, laptop or personal computers, wireless network-enabled key fobs, e-readers and the like. In many cases, the mobile wireless devices 62 may be configured to communicate wirelessly over the network 58 with the HVAC controller 18 via one or more wireless communication protocols including, but not limited to, cellular communication, ZigBee, REDLINK™, Bluetooth, WiFi, IrDA, dedicated short range communication (DSRC), EnOcean, and/or any other suitable common or proprietary wireless protocol, as desired.

In some cases, the HVAC controller 18 may be programmed to communicate over the network 58 with an external web service hosted by one or more external web servers 66. A non-limiting example of such an external web service is Honeywell's TOTAL CONNECT™ web service. The HVAC controller 18 may be configured to upload selected data via the network 58 to the external web service where it may be collected and stored on the external web server 66. In some cases, the data may be indicative of the performance of the HVAC system 4. Additionally, the HVAC controller 18 may be configured to receive and/or download selected data, settings and/or services including software updates from the external web service over the network 58. The data, settings and/or services may be received automatically from the web service, downloaded periodically in accordance with a control algorithm, and/or downloaded in response to a user request. In some cases, for example, the HVAC controller 18 may be configured to receive and/or download an HVAC operating schedule and operating parameter settings such as, for example, temperature set points, humidity set points, start times, end times, schedules, window frost protection settings, and/or the like. Additionally, the HVAC controller 18 may be configured to receive local weather data including the outdoor temperature, an outdoor temperature, an outdoor humidity, a solar load, a wind speed, weather alerts and/or warnings. The weather data may be provided by a different external server such as, for example, a web server maintained by the National Weather Service. These are just some examples.

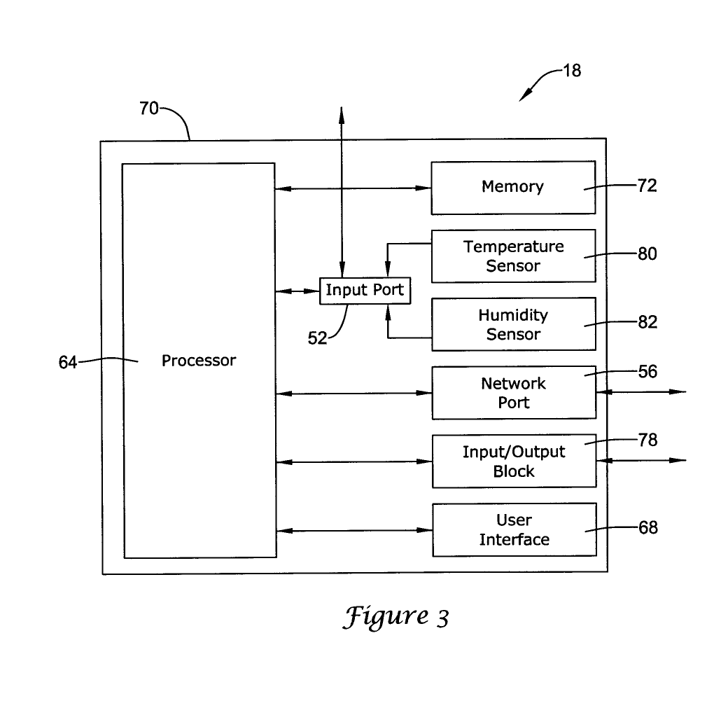

FIG. 3 is a schematic view of an illustrative HVAC controller 18. In some instances, the HVAC controller 18 may be a thermostat, but this is not required. Additionally, in some cases, the HVAC controller 18 may be accessed and/or controlled from a remote location over a computer network 58 (FIG. 2) using a mobile wireless device 62 such as, for example, a smart phone, a PDA, a tablet computer, a laptop or personal computer, a wireless network-enabled key fob, an e-Reader, and/or the like. As shown in FIGS. 2 and 3, the HVAC controller 18 may include an input port 52 for communicating with one or more internal and/or remotely located sensor 54. In some cases, the input port 52 may be in communication with one or more internal sensors. In addition, the input port 52 may be adapted to receive signals indicative of measures related to one or more environmental conditions inside or outside of the building. In some cases, the input port 52 may receive measures related to one or more environmental condition inside or outside of the building over a wireless network such as, for example, a wireless LAN, but this is not required. The network port 56 may be a wireless communications port including a wireless transceiver for sending and/or receiving signals over a wireless network 58 such as for example a wireless local area network (LAN) or a wide area network (WAN) such as, for example, the Internet. In some cases, the network port 56 may be in communication with a wired or wireless router or gateway for connecting to the network 58, but this is not required. In some cases, the router or gateway may be integral to the HVAC controller 18 or may be provided as a separate device.

Additionally, the illustrative HVAC controller 18 may include a processor (e.g. microprocessor, microcontroller, etc.) 64 and a memory 72. The processor 64 may be in communication with the input port 52 and/or the network port 56 and with the memory 72. The processor 64 and the memory 72 may be situated within a housing 70, which in some cases, may include at least one bracket for mounting the HVAC controller 18 to a wall located within the building or structure. In addition, the HVAC controller 18 may also include a user interface 68 including a display, but this is not required. In some instances, the user interface 68 may be secured relative to the housing 70. In other instances, the user interface 68 may be located at a remote device such as any one of the remote devices disclosed herein.

In some cases, the HVAC controller 18 may include a timer or clock (not shown). The timer may be integral to the processor 64 or may be provided as a separate component. The HVAC controller 18 may also optionally include an input/output block (I/O block) 78 for receiving one or more signals from the HVAC system 4 and/or for providing one or more control signals to the HVAC system 4. For example, the I/O block 78 may communicate with one or more HVAC components 6 of the HVAC system 4. Alternatively, or in addition to, the I/O block 78 may communicate with another controller, which is in communication with one or more HVAC components of the HVAC system 4, such as a zone control panel in a zoned HVAC system, equipment interface module (EIM) (e.g. EIM 34 shown in FIG. 1) or any other suitable building control device.

The HVAC controller 18 may include an internal temperature sensor 80 located within the housing 70, but this is not required. The HVAC controller may also include an internal humidity sensor 82 located within the housing 70, but this is also not required. The temperature sensor 80 and/or the humidity sensor 82 may be coupled to the input port 52 which, in turn, is coupled to the processor 64. In some cases, the HVAC controller 18 may communicate with one or more remote temperature sensors, humidity sensors, and/or occupancy sensors located throughout the building or structure via the input port 52 and/or network port 56. Additionally, in some cases, the HVAC controller may communicate with a temperature sensor and/or humidity sensor located outside of the building or structure for sensing an outdoor temperature and/or humidity if desired. As such, the HVAC controller 18 may receive at least one of a measure related to an indoor temperature inside the building or structure, a measure related to an indoor humidity inside the building or structure, and/or a measure related to an outdoor temperature and/or outdoor humidity outside of the building or structure. In some cases, the HVAC controller 18 may receive weather and/or other data via the network port 56, which may include, for example, outdoor temperature, outdoor humidity, wind speed and/or direction, solar load, etc., from a remote location such as a remote web server.

In the example shown, a controller such as processor 64 may operate in accordance with an algorithm that controls or at least partially controls one or more HVAC components of an HVAC system such as, for example, HVAC system 4 shown in FIG. 1. The processor 64, for example, may operate in accordance with a control algorithm that controls to temperature set points, humidity set points, an operating schedule, start and end times, window frost protection settings, operating modes, and/or the like. At least a portion of the control algorithm may be stored locally in the memory 72 of the HVAC controller 18. In some cases, the control algorithm (or portion thereof) may be stored locally in the memory 72 of the HVAC controller 18 and may be periodically updated in accordance with a predetermined schedule (e.g. once every 24 hours, 48 hours, 72 hours, weekly, monthly, etc.), updated in response to any changes to the control algorithm made by a user, and/or updated in response to a user's request. In some cases, at least a portion of the control algorithm and/or any updates to the control algorithm may be received from an external web service over the network 58.

In some cases, the processor 64 may operate according to a first operating mode having a first temperature set point, a second operating mode having a second temperature set point, a third operating mode having a third temperature set point, and/or the like. In some cases, the first operating mode may correspond to an occupied mode and the second operating mode may correspond to an unoccupied mode. In some cases, the third operating mode may correspond to a holiday or vacation mode wherein the building or structure in which the HVAC system 4 is located may be unoccupied for an extended period of time. In other cases, the third operating mode may correspond to a sleep mode wherein the building occupants are either asleep or inactive for a period of time. These are just some examples. It will be understood that the processor 64 may be capable of operating in additional modes as necessary or desired. The number of operating modes and the operating parameter settings (e.g. temperature set points, humidity set points, start and end times, etc.) associated with each of the operating modes may be established through a user interface 68 provided locally at the HVAC controller 18 or provided at a remote device, and/or through an external web service and delivered to the HVAC controller via the network 58 where they may be stored in the memory 72 for reference by the processor 64.

In some cases, the processor 64 may be programmed to determine a temperature offset based, at least in part, on a measure related to an indoor humidity and/or a measure related to an outdoor temperature, and to use the temperature offset in the control algorithm when controlling the HVAC system. The processor 64 may be programmed to apply the temperature offset to a temperature set point stored in the memory 72, which may result in a feels-like temperature set point. In some cases, the processor 64 may be programmed to apply the temperature offset to a temperature set point stored in the memory 72 for each operating mode of the HVAC system (e.g. home, away, sleep, vacation). The processor 64 may be further programmed to control the HVAC system in a manner that attempts to drive the indoor temperature toward the feels-like temperature in an attempt to increase a user's perceived comfort level. In other cases, the processor 64 may be programmed to apply the temperature offset to a measure related to a sensed indoor temperature, which may result in a feels-like temperature. The processor 64 may then be programmed to control the HVAC system in a manner that attempts to drive the feels-like temperature toward a temperature set point stored in the memory 72. In some cases, the temperature set point may be a user-specified temperature set point, which may be received from a user via the user interface 68 or the network 58.

In the illustrative embodiment of FIG. 3, the user interface 68, when provided, may be any suitable user interface that permits the HVAC controller 18 to display and/or solicit information, as well as accept one or more user interactions with the HVAC controller 18. For example, the user interface 68 may permit a user to locally enter data such as temperature set points, humidity set points, starting times, ending times, schedule times, diagnostic limits, responses to alerts, and the like. Additionally, the user interface 68 may permit to change a temperature set point, a humidity set point, a starting time, an ending time, a schedule time, a diagnostic limit, and the like. In one embodiment, the user interface 68 may be a physical user interface that is accessible at the HVAC controller 18, and may include a display and/or a distinct keypad. The display may be any suitable display. In some instances, a display may include or may be a liquid crystal display (LCD), and in some cases a fixed segment display or a dot matrix LCD display. In other cases, the user interface 68 may be a touch screen LCD panel that functions as both display and keypad. The touch screen LCD panel may be adapted to solicit values for a number of operating parameters and/or to receive such values, but this is not required. In still other cases, the user interface 68 may be a dynamic graphical user interface. Independent of the type of display, in some cases, the user interface 68 may be configured to display a feels-like temperature on the display such that it is visible to the user.

In some instances, the user interface 68 need not be physically accessible to a user at the HVAC controller 18. Instead, the user interface may be a virtual user interface 68 provided by an application program or “app” executed by a mobile wireless device such as, for example, a smartphone or tablet computer. Such a program may be available for download from an external web service such as, for example, Apple's iTunes, Google's Google Play, and/or Amazon's Kindle Store. Through the application program executed by the mobile wireless device, the processor 64 may be configured to display information relevant to the current operating status of the HVAC system 4 including the current operating mode, temperature set point, actual temperature within the building, feels-like temperature, outside temperature, outside humidity and/or the like. Additionally, the processor 64 may be configured to receive and accept any user inputs entered via the virtual user interface 68 including temperature set points, humidity set points, starting times, ending times, schedule times, window frost protection settings, diagnostic limits, responses to alerts, and the like.

In other cases, the user interface 68 may be a virtual user interface 68 that is accessible via the network 58 using a mobile wireless device such as one of those devices 62 previously described herein. In some cases, the virtual user interface 68 may include one or more web pages that are broadcasted over a network 58 (e.g. LAN or WAN) by an internal web server implemented by the processor 64. When so provided, the virtual user interface 68 may be accessed over the network 58 using a mobile wireless device 62 such as any one of those listed above. Through the one or more web pages, the processor 64 may be configured to display information relevant to the current operating status of the HVAC system 4 including the current operating mode, temperature set point, actual temperature within the building, a feels-like temperature, outside temperature, outside humidity and/or the like. Additionally, the processor 64 may be configured to receive and accept any user inputs entered via the virtual user interface 68 including temperature set points, humidity set points, starting times, ending times, schedule times, window frost protection settings, diagnostic limits, responses to alerts, and the like.

In still other cases, the virtual user interface 68 may include one or more web pages that are provided over the network 58 (e.g. WAN or the Internet) by an external web server (e.g. web server 66). The one or more web pages forming the virtual user interface 68 may be hosted by an external web service and associated with a user account having one or more user profiles. The external web server 66 may receive and accept any user inputs entered via the virtual user interface and associate the user inputs with a user's account on the external web service. If the user inputs include any changes to the existing control algorithm including any temperature set point changes, humidity set point changes, schedule changes, start and end time changes, window frost protection setting changes, operating mode changes, and/or changes to a user's profile, the external web server may update the control algorithm, as applicable, and transmit at least a portion of the updated control algorithm over the network 58 to the HVAC controller 18 where it is received via the network port 56 and may be stored in the memory 72 for execution by the processor 64.

The memory 72 of the illustrative HVAC controller 18 may be in communication with the processor 64. The memory 72 may be used to store any desired information, such as the aforementioned control algorithm, set points, schedule times, diagnostic limits such as, for example, differential pressure limits, delta T limits, and the like. The memory 72 may be any suitable type of storage device including, but not limited to, RAM, ROM, EPROM, flash memory, a hard drive, and/or the like. In some cases, the processor 64 may store information within the memory 72, and may subsequently retrieve the stored information from the memory 72.

A user's comfort level within a building or structure can be affected by multiple factors. These factors may include, but are not limited to, the HVAC system operating mode (e.g. heat or cool), indoor and/or outdoor humidity, indoor temperature including the dry bulb temperature, outdoor temperature, seasonal changes, the radiant wall temperature of the interior exterior walls of the building or structure, the user's gender, the solar load, outdoor wind speed, the amount of air movement within the building, the building occupancy level of the building, etc. In one example, in a heating mode, as the indoor humidity level increases, the perceived temperature also increases. In another example, in a heating mode, as the outdoor temperature decreases, the temperature of the exterior walls (radiant wall temperature) within the building tends to decrease, which causes the perceived temperature to also decrease. The degree to which the radiant wall temperature is affected by the outdoor temperature is dependent on the insulation rating of the exterior walls. In many cases, the outdoor temperature may have a substantially greater effect on the perceived temperature felt by the user than the indoor humidity level.

In some cases, a measure related to the outdoor temperature may be supplied to the HVAC controller 18 by an outdoor temperature sensor via the input port 52. In other cases, a measure related to the outdoor temperature may be extracted from weather data supplied to the HVAC controller 18 over a network via the network port 56. A measure related to the indoor humidity may be received by the HVAC controller 18 via the input port 52 from an internal humidity sensor located within the housing 70 of the HVAC controller 18 or an external indoor humidity sensor located remotely from the HVAC controller 18.

In one example, a feels-like temperature may be determined by the processor 64 based, at least in part, on an indoor dry bulb temperature, an outdoor temperature and an indoor humidity. In some cases, the feels-like temperature may be determined by applying an outdoor temperature correction factor and an indoor humidity correction factor to the indoor dry bulb temperature sensed by the HVAC controller 18. In other cases, an outdoor temperature correction factor and an indoor humidity correction may be applied to a user-specified set point stored in the memory 72 of the HVAC controller 18.

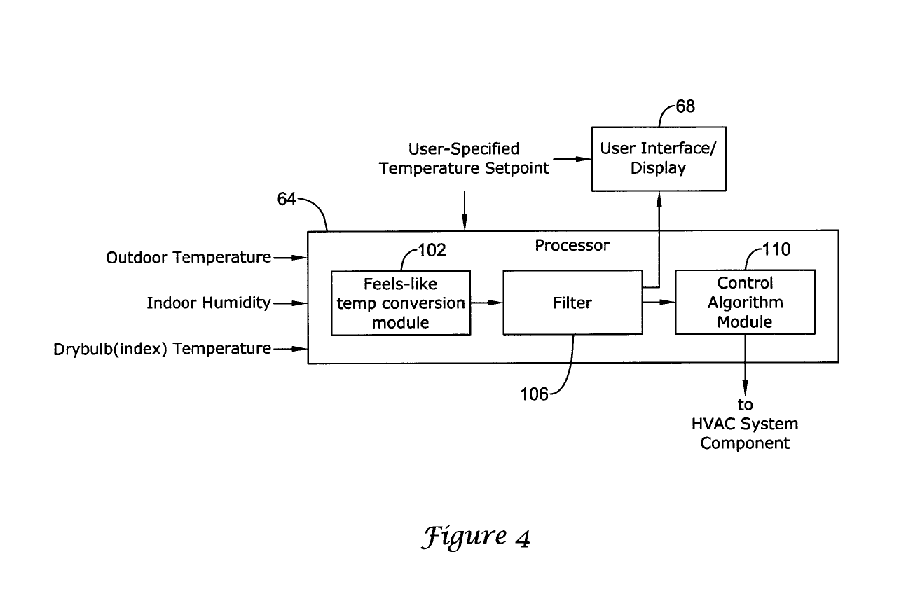

FIG. 4 is a flow diagram outlining an illustrative process that may be utilized by the processor 64 to determine a feels-like temperature. As can be seen in FIG. 4, the processor 64 may include a feels-like temperature conversion module 102, which may be configured to receive at least measure related to an indoor temperature (e.g. the dry bulb temperature), a measure related to an outdoor temperature, and a measure related to an indoor humidity. The feels-like temperature conversion module 102 may determine a correction factor, which may be a function of the indoor temperature, the indoor humidity and/or the outdoor temperature. The correction factor may be applied to the dry bulb temperature to convert the dry bulb temperature to a feels-like temperature. In some cases, the feels-like temperature value determined by the feels-like temperature conversion module 102 may be filtered by a filter module 106 to minimize the effect that a seasonal transition or seasonal shift in outdoor temperature may have on the feels-like temperature value, but this is not required. The feels-like temperature value may then be delivered to a control algorithm module 110 for controlling the HVAC system 4, and in some cases, to the user interface 68 where the feels-like temperature value may be displayed to the user on a display as the current indoor temperature. In some cases, the feels-like temperature value that is displayed to the user may not be identified as a feels-like temperature. Rather, it may be simply displayed to the user along with the user-specified temperature set point. During operation, the displayed feels-like temperature value will be driven toward the displayed set point by the HVAC system.

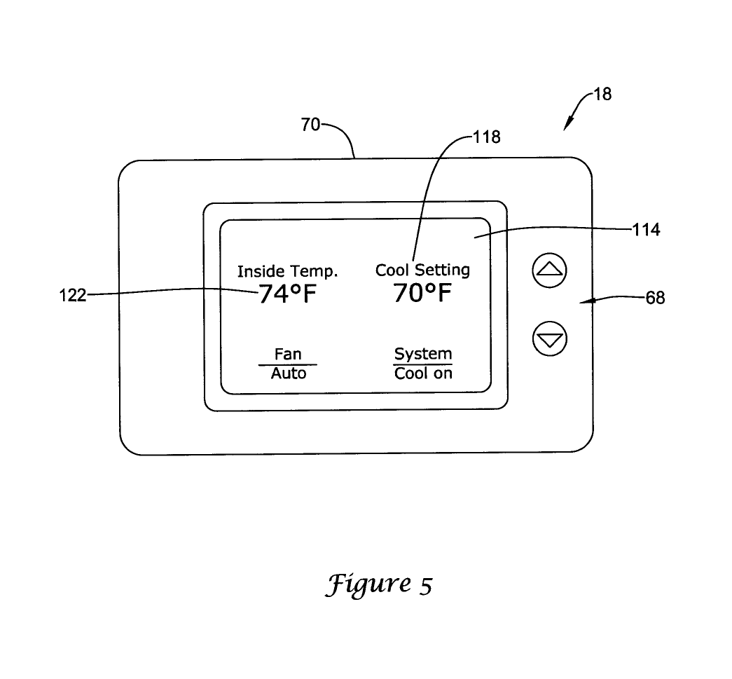

FIG. 5 is a schematic view of an illustrative HVAC controller 18 having a housing 70 and a user interface 68 including a display 114. The display 114 may be any suitable display. In some cases, the display 114 may include or may be a liquid crystal display (LCD), and in some cases a fixed segment display or a dot matrix LCD display. As shown in FIG. 5, the temperature set point 118 along with an inside temperature value 122 may be displayed to a user via the display 114 of the user interface 68. As discussed herein, the inside temperature value 122 that is displayed to the user via the display 114 of the user interface 68 may be the feels-like temperature determined by the processor 64 according to one of the various algorithms as disclosed herein. It will be generally understood, the user interface 68, when provided at a remote device, may also display the temperature set point 118 along with an inside temperature value 122.

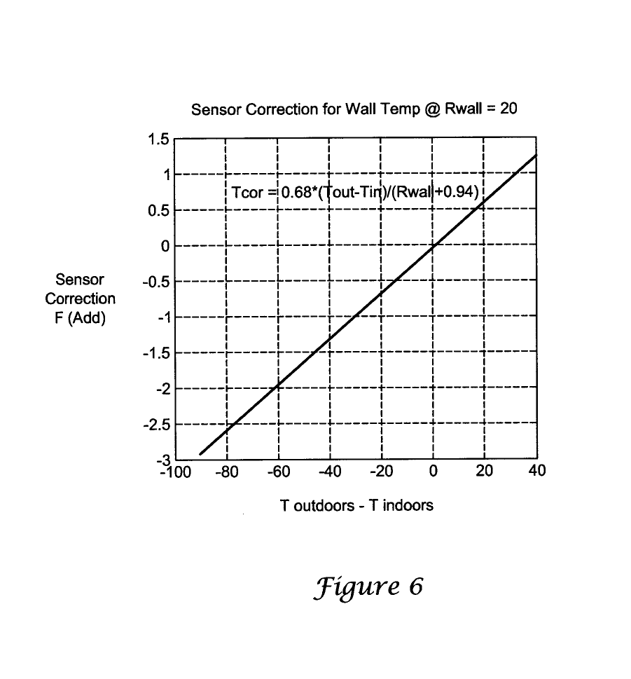

FIG. 6 is a graphical representation of an exemplary calculation that may be used to determine a temperature correction factor based, at least in part, on an indoor temperature and an outdoor temperature. As can be seen in FIG. 6, the temperature correction factor based on the indoor temperature and the outdoor temperature may be determined by the following equation:

T_{outdoor temp correction}=0.68×(T_{outdoor}−T_{indoor})/(R_{wall}+0.94) Eq. 1

where T_{outdoor} is the outdoor temperature, T_{indoor} is the indoor temperature or dry bulb temperature, and R_{wall} is the radiant wall temperature. In this example, a R20 insulation value is assumed.

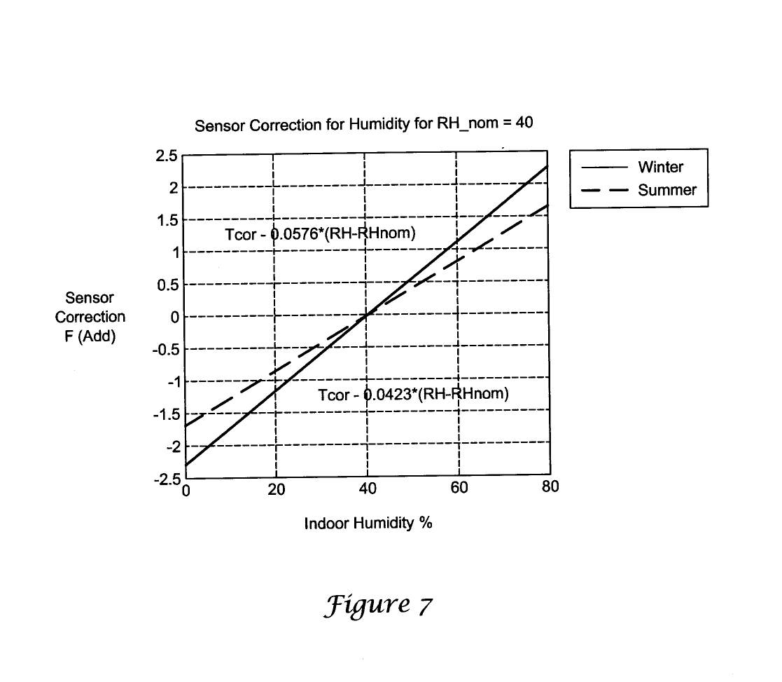

FIG. 7 is a graphical representation of an exemplary calculation that may be used to determine a humidity correction factor based, at least in part, on an indoor humidity value. As can be seen in FIG. 7, a different humidity correction factor may be calculated for winter (heating mode) than for summer (cooling mode) using the following equations:

Winter: T_{indoor humidity correction}=0.0576×(RH_{sensed}−RHₙₒₘ) Eq. 2

Summer: T_{indoor humidity correction}=0.0423×(RH_{sensed}−RHₙₒₘ) Eq. 3

where RH_{sensed} is the sensed indoor humidity and RHₙₒₘ is an assumed average indoor humidity value which in this example is 40% relative humidity. In some cases, the summer humidity correction factor may be the default humidity correction factor, but this is not required.

In one example, the outdoor temperature correction factor T_{outdoor temp correction} and the indoor humidity correction factor T_{indoor humidity correction} may be applied to a sensed dry bulb temperature to determine a feels-like temperature according to the following exemplary equation:

T_{feels-like temp}=T_{dry bulb temp}+T_{outdoor temp correction}+T_{indoor humidity correction} Eq. 4a

In another example, the outdoor temperature correction factor T_{outdoor temp correction} and the indoor humidity correction factor T_{indoor humidity correction} may be applied to a temperature set point stored in the memory 72 of the HVAC controller 18 to determine a feels-like temperature set point according to the following equation.

T_{feels-like temp set point}=T_{set point}−T_{outdoor temp correction}−T_{indoor humidity correction} Eq. 4b

Equations 1-4b are example equations that can be seen to account for the effect that the outdoor temperature and the indoor humidity may have on a user's perceived comfort level, Equations 1-4b make several assumptions, and do not necessarily account for other possible factors that may affect a user's perceived comfort level.

The following set of exemplary equations also may be used to determine a feels-like temperature, and take into account other factors affecting a user's perceived comfort level including a Predicted Mean Vote (PMV) factor, dry bulb temperature, relative humidity, radiant wall temperature, user gender, heat transfer, and temperature set point.

A PMV scale may range from −3 to +3, and may correspond to an average human perception of thermal comfort, as shown below in Table 1.

TABLE 1

| | Physical |
|---|---|
| PMV | perception |
| +3 | Hot |
| +2 | Warm |
| +1 | Slightly warm |
| 0 | Neutral |
| −1 | Slightly cool |
| −2 | Cool |
| −3 | Cold |

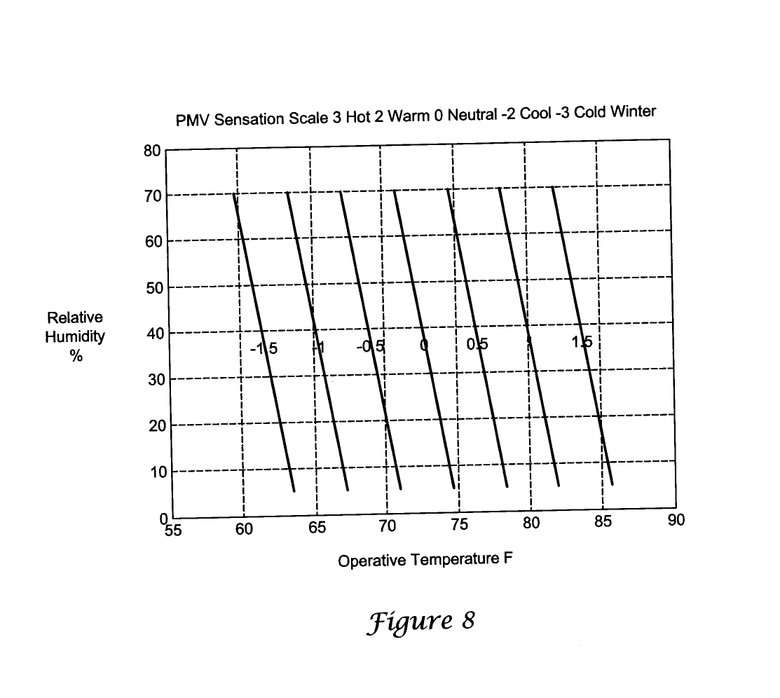

Test subjects may be exposed to various temperature conditions and asked to “vote” on how they perceived their temperature environment using the above scale. The PMV may be a function of, for example, relative humidity, dry bulb temperature, outdoor temperature, activity level and the insulation value of the clothing worn by the test subjects. The lines of constant PMV (constant “feels like” temperature) for typical indoor winter clothing and moderate activity levels are shown in FIG. 8. The exemplary PMV Sensation Scale shown in FIG. 8 demonstrates that a cooler temperature at a higher humidity level may feel-like a warmer temperature at a lower humidity level. In some cases, the HVAC controller 18 may query the user via the display 114 under various temperature and humidity conditions to help build a PMV model for the occupants of the building.

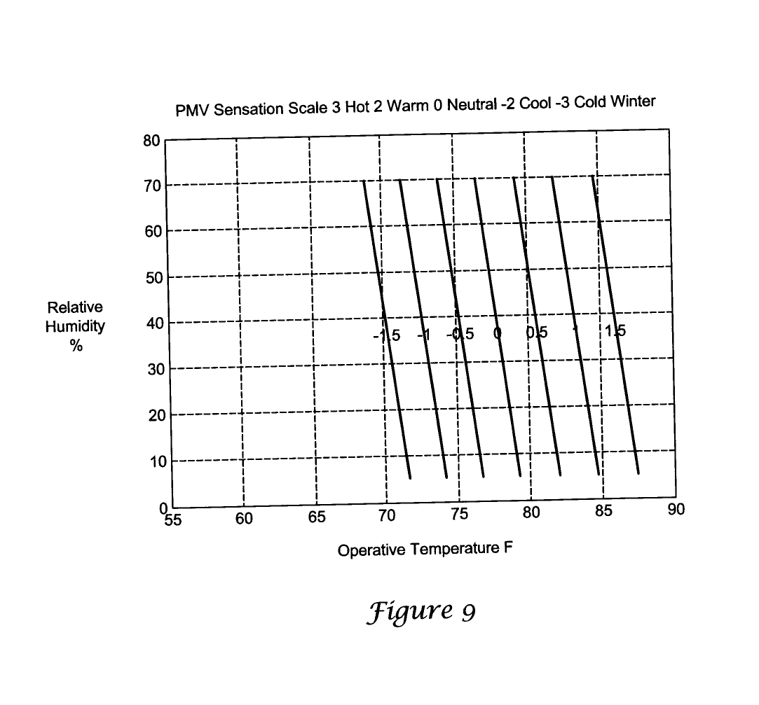

Test subjects may also be asked to evaluate their comfort level when wearing clothing typical of summer weather and winter weather. FIG. 9 shows an exemplary PMV scale for typical indoor summer clothing and moderate activity levels. As can be seen, the lines of constant PMV shift toward a higher temperature and are closer together relative to that shown in FIG. 8.

In the example shown, the operative temperature scale shown in FIGS. 8 and 9 is the dry bulb air temperature that test subjects were exposed to over a range of humidity values in a test chamber of which the walls, floor, and ceiling temperature were caused to be equal to the dry bulb air temperature. This eliminated the effect of radiant heat exchange with the surfaces of the room. Additionally, a correction factor was added to the operative temperature to account for radiant heat transfer between people and the surrounding surfaces.

In one example, and using the PMV scales, a matrix calculation and a linear two dimension curve fit on the matrix calculation may be used to determine a relationship between PMV, the operative temperature Tₒₚₑᵣ and the relative humidity (RH). The illustrative mathematical relationship between PMV, the operative temperature Tₒₚₑᵣ and the relative humidity (RH) can be represented by Equation 5 presented below:

$$PMV = aToper + b \frac{RH}{100} + c \qquad Eq . 5$$

where a, b, and c are the fitting coefficients which illustrative values are presented in Table 2 shown below; Tₒₚₑᵣ is the operative temperature (degrees Fahrenheit (F)); and RH is the percent relative humidity.

TABLE 2

| Season | a | b | c |
|---|---|---|---|
| Winter | 0.136 | 0.785 | −10.2 |
| Summer | 0.186 | 0.785 | −14.75 |

The operative temperature Tₒₚₑᵣ may be expressed using Equation 6, which is provided below:

$$Toper = \frac{[ \begin{matrix}0.18 ( Tup + Tdown ) + 0.22 ( Tright + Tleft ) + \\ 0.3 ( Tfront + Tback )\end{matrix} ]}{2 ( 0.18 + 0.22 + 0.3 )} \qquad Eq . 6$$

TABLE 3

| | Surface at the |
|---|---|
| Temperature | temperature |
| Tup | Ceiling |
| Tdown | Floor |
| Tright | Right hand wall |
| Tleft | Left hand wall |
| Tfront | Front wall |
| Tback | Back wall |

Equation 6 assumes that the user is sitting in a room having two outside walls and a ceiling, of which all three are exposed to an outside air temperature, while the floor and the other two walls of the room are exposed to the indoor air temperature on both sides. An example of such a room would be a corner room in a house having an unconditioned attic space above the room and a conditioned space below the room. In this example, the outside walls are cooler than the indoor air in winter because of the conduction of heat from the inside to the outside cools the wall surface. The inside walls were assumed to be at the same temperature as the indoor air because the inside walls are exposed to indoor air on both sides. Under these conditions, the correction to the sensed indoor dry-bulb temperature (Tin) was determined using the following equation:

$$Toper = \frac{[ \begin{matrix}0.18 ( Tin - Δ Tw + Tin ) + 0.22 ( Tin - Δ Tw + Tint ) + \\ 0.3 ( Tin - Δ Tw + Tin )\end{matrix} ]}{2 ( 0.18 + 0.22 + 0.3 )} \qquad Eq . 7$$

where the temperature of the two outside walls and the temperature of the ceiling are equal to the dry bulb air inside temperature (Tin) minus the temperature drop (drop in winter, rise in summer) from the air to the walls surfaces caused by heat transfer (ΔTw). The two walls and the floor that are not exposed to outside air were assumed to be at the inside dry bulb air temperature (Tin). Equation 7 was then simplified to yield the following equation:

$$Toper = \frac{[ 2 Tin ( 0.18 + 0.22 + 0.3 ) - Δ Tw ( 0.18 + 0.22 + 0.3 ) ]}{2 ( 0.18 + 0.22 + 0.3 )} = Tin - 0.5 Δ Tw \qquad Eq . 8$$

The term ΔTw is a heat transfer term, and represents the temperature drop from the sensed dry bulb air temperature to the temperature of the inside wall surface that is caused by the heat flow from the inside air, through the wall to the outside. The term ΔTw was derived using, at least in part, the following heat transfer equation:

$$Q = hA ( Tin - Tout ) = \frac{1}{R} A ( Tin - Tout ) \qquad Eq . 9$$

where R is the thermal resistance from the inside air to the outdoor air. The thermal resistance R is the sum of three separate terms: the thermal resistance of an air film from the inside air through a thermal boundary layer to the wall (0.68 for inside film resistance); the thermal resistance of the wall itself of which its R value, Rwall, is about R 20; and the thermal resistance of an air film from the outside wall surface to the bulk temperature of the outside air (0.26 for outside air). From this, the heat flux (q) in BTU per square foot for temperatures in degrees F. was determined using the following equation:

$$q = \frac{( Tin - Tout )}{( 0.68 + Rwall + 0.26 )} \qquad Eq . 10$$

The temperature drop from the inside air to the wall surface was assumed to be equal to the heat flux (q) multiplied by the inside film resistance (0.68). As such, the following equation was used to determine ΔTw.

$$Δ Tw = 0.68 q = \frac{0.68 ( Tin - Tout )}{( 0.68 + Rwall + 0.26 )} \qquad Eq . 11$$

Gender was also determined to be a factor that may affect a user's perceived comfort. For example, on average, women prefer to be 1.5 degree F. warmer than men. As such, a gender term may be provided, which may provide a gender offset component between the operative temperature and the dry bulb temperature. The gender offset (ΔTmfb) may have a value for males of (−0.86), females (+0.7) and zero for a mixed gender set of occupants.

According to various embodiments, a user may specify a temperature set point Tsetd via the user interface 68 of the HVAC controller. The set point specified by the user Tsetd may be the ideal temperature which the user would like to experience, and may be indicative of their perceived comfort level. As various conditions change within and/or outside of the building, the HVAC controller 18 may, for example, maintain the temperature within the space along a same PMV line (feels-like temperature) that was initially indicated by the user's specified temperature set point Tsetd.

In some cases, the processor 64 of the HVAC controller 18 may be programmed to determine and/or apply a temperature offset to the sensed dry bulb temperature value to determine a feels-like temperature that may then be utilized in the control algorithm for controlling one or more components of the HVAC system 4. In many cases, the user-specified temperature set point Tsetd and the feels-like temperature determined by the processor 64 and utilized in the control algorithm to control one or more components of the HVAC system 4 may differ. The control algorithm may be configured to control the HVAC system according to the feels-like temperature in a manner that attempts to drive the feels-like temperature toward the user-specified temperature set point Tsetd stored in the memory 72 of the HVAC controller 18 until the feels-like temperature converges on the user-specified temperature set point Tsetd. In some cases, the HVAC controller 18 may be configured to display both the user-specified temperature set point Tsetd and the feels-like temperature (adjusted dry bulb temperature value utilized by the control algorithm) via the user interface 68. In some cases, the feels-like temperature may not be identified as a feels-like temperature, but rather may be simply identified to the user via the user interface 68 as the current sensed temperature. This may help avoid confusion on the user's part.

The following equations demonstrate how the feels-like temperature may be derived taking into account the user-specified temperature set point Tset along with the other factors already discussed herein. First, it is assumed that the user's ideal perceive comfort level is achieved at some ideal humidity (RHideal) when the indoor wall surfaces are at the same temperature as the indoor air. The ideal humidity may be assumed to be somewhere in the middle of the ASHRAE comfort zone and may range from, for example, 35 to 40 percent. Under these ideal conditions, the operative air temperature may be assumed to be equal to the dry bulb temperature such that the heat transfer term ΔTw equals zero. Next, the PMV equation can be used to determine a PMV value (PMVo) that may satisfy the user's desire to be comfortable under all conditions. The equation may be as follows:

$$PMVo = aTsetd + b \frac{RHideal}{100} + c \qquad Eq . 12$$

Equation 5 is then solved to determine the operative temperature as a function of PMV.

$$Toper = \frac{PMV - b \frac{RH}{100} - c}{a} \qquad Eq . 13$$

Next, the operative temperature Toper is corrected for radiant wall temperature and gender.

Toper=Tin−0.5ΔTw+ΔTmfb Eq. 14

Equations 13 and 14 are combined to determine the feels-like dry bulb temperature (Tin) for any desired PMV value at any RH and ΔTw.

$$Tin = \frac{PMV - b \frac{RH}{100} - c}{a} + 0.5 Δ Tw - Δ Tmfb \qquad Eq . 15$$

The right hand side of equation 12 is substituted in for the PMV value in equation 15 above to determined an expression for the actual dry bulb set point Tset to achieve the user-specified temperature Tsetd desired by the user.

$$Tin = \frac{aTsetd + b \frac{RHideal}{100} + c - b \frac{RH}{100} - c}{a} + 0.5 Δ Tw - Δ Tmfb \qquad Eq . 16$$

Equation 16 is then simplified to yield the following equation:

$$Tset = Tsetd + \frac{b}{a} \frac{( RHideal - RH )}{100} + 0.5 Δ Tw - Δ Tmfb \qquad Eq . 17$$

Note that the constant (c) subtracts out of the equation. Next, the right hand side of equation 11 is used to determined ΔTw and is substituted into equation 17 above to yield the following equation:

$$Tset = Tsetd + \frac{b}{a} \frac{( RHideal - RH )}{100} + 0.5 \frac{0.68 ( Tset - Tout )}{( 0.68 + Rwall + 0.26 )} - Δ Tmfb \qquad Eq . 18$$

Equation 18 is then solved to determine the dry bulb set point or feels-like temperature set point (Tset) which may then be utilized by the control algorithm to control the one of more components of the HVAC system 4.

$$Tset = \frac{Tsetd + \frac{b}{a} \frac{( RHideal - RH )}{100} - \frac{0.68 Tout}{2 ( \begin{matrix}0.68 + \\ Rwall + \\ 0.26\end{matrix} )} - Δ Tmfb}{[ 1 - \frac{0.68}{2 ( 0.68 + Rwall + 0.26 )} ]} \qquad Eq . 19$$

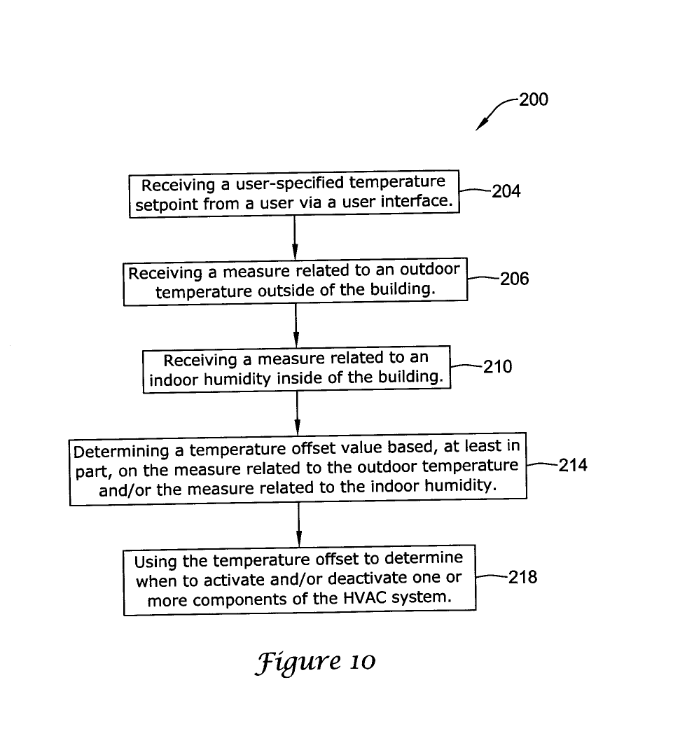

FIG. 10 is a flow chart of an illustrative method 200 of controlling one or more components 6 of an HVAC system 4 according to a feels-like temperature. According to the illustrative method 200, an HVAC controller 18 may receive a user-specified temperature set point or set point change entered by a user via the user interface 68 of the HVAC controller 18 (Block 204). As discussed herein, the user interface 68 may be provided locally at the HVAC controller 18 or, in some cases, the user interface 68 may be provided at a remote device which may be in communication with the HVAC controller 18. In addition, the HVAC controller 18 may receive a measure related to an outdoor temperature outside of the building or structure in which the HVAC controller 18 may be located (Block 206). The outdoor temperature may be contained within weather data that is delivered to the HVAC controller of a network such as, for example, the Internet. In other cases, the HVAC controller 18 may receive a signal indicative of an outdoor temperature from an outdoor temperature sensor mounted proximate to the building. The HVAC controller 18 may also receive a measure related to an indoor humidity from an indoor humidity sensor located within the building (Block 210). In many cases, the HVAC controller 18 may determine a temperature offset value based, at least in part, on the measure related to the outdoor temperature and/or the measure related to the indoor humidity (Block 214). The HVAC controller 18 may then use the temperature offset value to determine when to activate and/or deactivate one or more components 6 of the HVAC system 4 (Block 218). For example, in some cases, the HVAC controller 18 may apply the temperature offset value to the measure related to the indoor temperature, resulting in a feels-like temperature and then, in turn, activate and/or deactivate one or more components of the HVAC system 4 in an attempt to drive the feels-like temperature toward the user-specified temperature set point. In other cases, the HVAC controller 18 may apply the temperature offset value to the user-specified temperature set point, resulting in a feels-like temperature set point and then, activate and/or deactivate one or more components of the HVAC system in accordance with the feels-like temperature set point.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respect, only illustrative. Changes may be made in details, particularly in matters of shape, size, and arrangement of parts without exceeding the scope of the disclosure. The disclosure's scope is, of course, defined in the language in which the appended claims are expressed

What is claimed is:

1. An HVAC controller for controlling one or more HVAC components of an HVAC system of a building or structure, the HVAC controller comprising:
a memory including a control algorithm stored therein for controlling the one or more HVAC components of the HVAC system, the memory further storing a temperature set point;
an input port for receiving:
a measure related to an indoor temperature inside the building or structure;
a measure related to an indoor humidity inside the building or structure;
a measure related to an outdoor temperature outside of the building or structure; and
a controller coupled to the memory and the input port, the controller programmed to determine a temperature offset based, at least in part on the measure related to the indoor humidity and the measure related to the outdoor temperature, and to use the temperature offset in the control algorithm when controlling the HVAC system.

2. The HVAC controller of claim 1, wherein the controller is programmed to apply the temperature offset to the temperature set point stored in the memory, resulting in a feels-like temperature set point, and wherein the control algorithm is configured to control the HVAC system in a manner that attempts to drive the measure related to the indoor temperature toward the feels-like temperature set point.

3. The HVAC controller of claim 1, wherein the controller is programmed to apply the temperature offset to the measure related to the indoor temperature, resulting in a feels-like temperature, and wherein the control algorithm is configured to control the HVAC system in a manner that attempts to drive the feels-like temperature toward the temperature set point stored in the memory.

4. The HVAC controller of claim 1 further comprising:
a user interface including a display; and
wherein the temperature set point stored in the memory can be changed via the user interface.

5. The HVAC controller of claim 4, further comprising a housing, wherein the memory and the controller are situated inside of the housing.

6. The HVAC controller of claim 5, further comprising:
a temperature sensor situated inside of the housing coupled to the input port for providing the measure related to the indoor temperature inside of the building or structure; and
a humidity sensor situated inside of the housing coupled to the input port for providing the measure related to the indoor humidity inside of the building or structure.

7. The HVAC controller of claim 6, further comprising:
an outdoor temperature sensor situated outside of the housing for providing the measure related to the outdoor temperature outside of the building or structure.

8. The HVAC controller of claim 6, further comprising a network port coupled to the input port for communicating over a network, the network port receiving the measure related to the outdoor temperature outside of the building or structure from a remote location.

9. The HVAC controller of claim 5, wherein the user interface is secured relative to the housing.

10. The HVAC controller of claim 5, wherein the user interface is located on a remote device that is located remote from the housing.

11. The HVAC controller of claim 3 further comprising:
a housing, wherein the memory and the controller are situated inside of the housing;
a user interface including a display, wherein the temperature set point stored in the memory can be changed via the user interface; and
wherein the controller is configured to display the feels-like temperature on the display.

12. An HVAC controller for controlling one or more HVAC components of an HVAC system of a building or structure, the HVAC controller comprising:
a memory including a control algorithm stored therein for controlling the one or more HVAC components of the HVAC system, the memory further storing a temperature set point;
an input port for receiving:
a measure related to an indoor temperature inside the building or structure;
a measure related to an outdoor temperature outside of the building or structure; and
a controller coupled to the memory and the input port, the controller programmed to determine a temperature offset based, at least in part on the measure related the outdoor temperature, and to use the temperature offset in the control algorithm when controlling the HVAC system.

13. The HVAC controller of claim 12, wherein the controller is programmed to apply the temperature offset to the temperature set point stored in the memory, resulting in a feels-like temperature set point, and wherein the control algorithm is configured to control the HVAC system in a manner that attempts to drive the measure related to the indoor temperature toward the feels-like temperature set point.

14. The HVAC controller of claim 12, wherein the controller is programmed to apply the temperature offset to the measure related to the indoor temperature, resulting in a feels-like temperature, and wherein the control algorithm is configured to control the HVAC system in a manner that attempts to drive the feels-like temperature toward the temperature set point stored in the memory.

15. The HVAC controller of claim 12 further comprising:
a user interface including a display;
wherein the temperature set point stored in the memory can be changed via the user interface;
a housing, wherein the memory and the controller are situated inside of the housing; and
an outdoor temperature sensor situated outside of the housing for providing the measure related to the outdoor temperature outside of the building or structure.

16. The HVAC controller of claim 15, wherein the user interface is secured relative to the housing.

17. The HVAC controller of claim 15, wherein the user interface is located on a remote device that is located remote from the housing.

18. A method of controlling one or more components of an HVAC system of a building, the method comprising:
receiving a user-specified temperature set point from a user via a user interface associated with an HVAC controller;
receiving a measure related to an outdoor temperature outside of the building;
receiving a measure related to a indoor humidity inside of the building;
determining a temperature offset value based, at least in part, on the measure related to the outdoor temperature and/or the measure related to the indoor humidity; and
using the temperature offset value to determine when to activate and/or deactivate one or more components of the HVAC system.

19. The method of claim 18 further comprising:
receiving a measure related to an indoor temperature;
applying the temperature offset value to the measure related to the indoor temperature, resulting in a feels-like temperature; and
activating and/or deactivating one or more components of the HVAC system in an attempt to drive the feels-like temperature toward the user-specified temperature set point.

20. The method of claim 18 further comprising:
receiving a measure related to an indoor temperature;
applying the temperature offset value to the user-specified temperature set point, resulting in a feels-like temperature set point; and
activating and/or deactivating one or more components of the HVAC system in an attempt to drive the measure related to the indoor temperature toward the feels-like temperature set point.
